(19) United States
(12) Patent Application Publication
(10) Pub. No.: US 2024/0153225 A1
(43) Pub. Date: May 9, 2024

(54) SYSTEM AND METHOD FOR LANGUAGE-DRIVEN AVATAR EDITING

(71) Applicant: SAMSUNG ELECTRONICS CO., LTD., Suwon-si (KR)

(72) Inventors: Daryl Luciano PERALTA, Quezon City (PH); Amielle Barrion DULAY, Sta. Rosa City (PH)

(73) Assignee: SAMSUNG ELECTRONICS CO., LTD., Suwon-si (KR)

(21) Appl. No.: 18/244,640

(22) Filed: Sep. 11, 2023

(30) Foreign Application Priority Data
Nov. 7, 2022 (PH) 1-2022-050543

(51) Int. Cl. G06T 19/20; G06T 13/40

(52) U.S. Cl. CPC G06T 19/20; G06T 13/40; G06T 2219/2004; G06T 2219/2012

(57) ABSTRACT

According to an embodiment of the disclosure, a method for editing avatar model based on language-driven, the method comprising: receiving a first input including language description, obtaining a first latent vector based on the first input, updating an initial avatar model to a first three-dimensional avatar model based on the first latent vector, displaying the first three-dimensional avatar model.

### CROSS-REFERENCE TO RELATED APPLICATION(S)

This application is based on and claims priority under 35 U.S.C. § 119 to Philippine Patent Application No. 1-2022-050543, filed on Nov. 7, 2022, in the Philippine Intellectual Patent Office, the disclosure of which is incorporated by reference herein in its entirety.

### TECHNICAL FIELD

An embodiment of the disclosure is related to a system and method for avatar editing and customization for mobile devices, VR hardware, and other digital device apparatus in the field of machine learning. An embodiment of the disclosure specifically relate to devices, methods, and systems in the automated language-driven avatar editing for mobile devices.

### BACKGROUND OF THE INVENTION

The human body is fundamental in how humans interact with the physical world and other humans. Body gestures, body expressions, clothing, and appearance communicate a lot about a person. Representing the human body in the digital space as 3D avatars have been an interest in the fields of computer vision and computer graphics. Digital 3D avatars provide a more expressive way to communicate in the digital space.

The manual method to create photorealistic 3D avatars is time-consuming as it would require someone skilled in 3D modeling. Customizing 3D avatars also takes time and requires creating 3D assets of predefined body shapes, accessories, skin color, among others.

### SUMMARY

According to an embodiment of the disclosure, the method may include receiving a first input including language description.

According to an embodiment of the disclosure, the method may include obtaining a first latent vector based on the first input.

According to an embodiment of the disclosure, the method may include updating an initial avatar model to a first three-dimensional avatar model based on the first latent vector.

According to an embodiment of the disclosure, the method may include displaying the first three-dimensional avatar model.

According to an embodiment of the disclosure, the device may include at least one memory storing at least one instruction and at least one processor configured to execute the at least one instruction stored in the memory.

According to an embodiment of the disclosure, at least one processor is configured to receive a first input including language description.

According to an embodiment of the disclosure, at least one processor is configured to obtain a first latent vector based on the first input.

According to an embodiment of the disclosure, at least one processor is configured to update an initial avatar model to a first three-dimensional avatar model based on the first latent vector.

According to an embodiment of the disclosure, at least one processor is configured to display the first three-dimensional avatar model.

### BRIEF DESCRIPTION OF DRAWINGS

The accompanying drawings are useful for understanding an embodiment of the disclosure. In the drawings:

FIG. 1 illustrates a diagram of the system according to an embodiment of the disclosure.

FIG. 2 illustrates the high-level operation of a method with a given language description (auditory and text inputs), according to an embodiment of the disclosure.

FIG. 3 illustrates the block diagram, according to an embodiment of the disclosure.

FIG. 4 illustrates a method, according to an embodiment of the disclosure.

FIG. 5 illustrates the flowchart of an embodiment of the disclosure pertaining to the avatar database retrieval method.

FIG. 6 illustrates an embodiment of the disclosure as deployed in a mobile device.

FIG. 7 illustrates the method of an embodiment of the disclosure.

FIG. 8 illustrates an embodiment of the disclosure as deployed in a virtual reality (VR) headset.

FIG. 9 illustrates an embodiment of the disclosure wherein the text description is used alongside a speech input to generate the avatar.

FIG. 10 illustrates an embodiment of the disclosure wherein the received input to generate the avatar has a similar corresponding query in the database. The 3D avatar model which corresponds to a similar query found is displayed back to the user.

FIG. 11 illustrates the animation component of an embodiment of the disclosure utilizing automatic rigging algorithms to animate the avatars.

### DETAILED DESCRIPTION OF THE INVENTION

An embodiment of the disclosure is related to a system and method to update a digital human 3D model based on a language description of the target 3D model shape and appearance. The method has the capacity to receive user input for requests such as but not limited to audio, video, text, photo, compiled instructions, customized files, sensor data, user-selected options, or a combination of multi-modal input, etc., which define a language description for the model update.

An embodiment of the disclosure may provide customizability such that the creation of non-existent avatars in a device does not necessarily require having to manually build it. An embodiment of the disclosure may provide more efficient systems and methods of generating avatars compared to non-lingual and manual select and customize the user interface (UI), while existing methods to edit avatars require predefined 3D models, styles, and textures, among others, and focus on manual editing and selection of avatars.

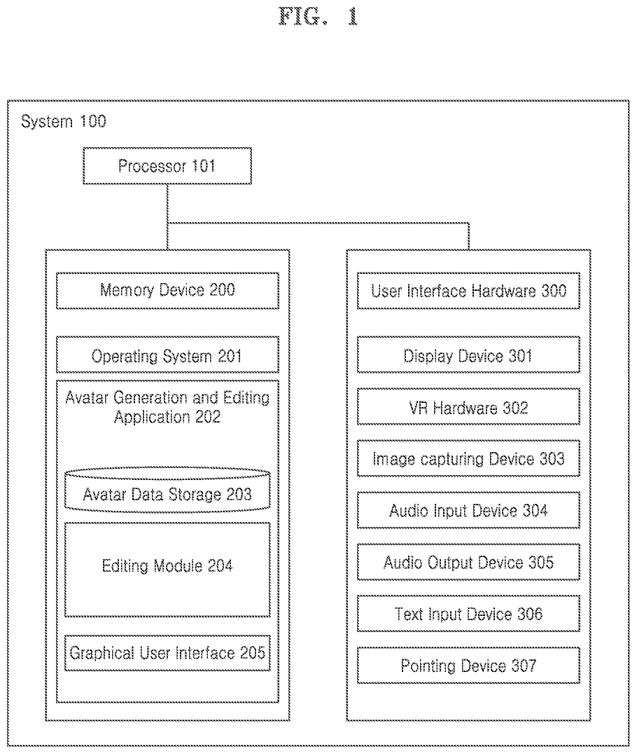

FIG. 1 illustrates a block diagram of system 100 according to an embodiment of the disclosure. As shown in FIG. 1, according to an embodiment of the disclosure, the system may comprise an at least one processor 101 in communication with two modules, namely, an at least one memory device 200 and an at least one user interface hardware 300.

According to FIG. 1, system 100 consists of:
1. an at least one processor 101;
2. at least one memory device 200 to store the software components such as an at least one operating system 201 and an at least one avatar generation and editing application 202, further comprising of an at least one avatar data storage 203, an at least one language-driven editing module 204, and at least one graphical user interface 205;
3. the at least one user interface hardware 300 to receive input and generate output for user interaction. Hardware 300 may include devices such as but not limited to touch screen display 301, virtual reality hardware (VR hardware) 302, image capturing device 303, audio input device 304, audio output device 305, text input device 306, and pointing device 307;
4. the at least one avatar generation and editing application 202 further consisting of:
a. at least one avatar data storage 203 to store existing avatars;
b. at least one graphical user interface (GUI) 205; and
c. other modules related to the generation of avatars (not shown).

The components and/or subcomponents described may be split further, combined, or both in terms of operation, implementation, and/or deployment.

The VR hardware 302 may include a headset with a display for each eye and a processor and a memory for control of the displays. The VR hardware may operate in conjunction with a mobile phone.

The image capturing device 303 may be a camera.

The audio input device 304 may be a microphone.

The audio output device 305 may be a speaker.

The text input device 306 may be a keyboard or touch screen.

The pointing device 307 may be a mouse.

The graphical user interface 205 may include a display screen, a keyboard, and a pointing device.

The editing module 204, the avatar generation and editing application 202 may be software executing instructions stored in the memory device 200 by the processor 101.

Modules, units, functions and logic of an embodiment of the disclosure may be implemented by the processor 101 executing instructions stored in memory device 200.

Examples of other applications that are stored in memory device 200 include other word processing applications, other image editing applications, drawing applications, presentation applications, JAVA-enabled applications, encryption, digital rights management, voice recognition, and voice replication.

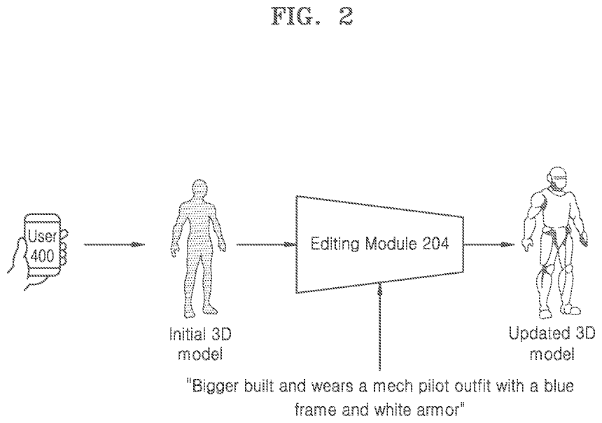

FIG. 2 shows the main representation of the language-driven editing module 204.

It is conceivable that user 400 may create a virtual character specific to the user through a mobile client and upload the virtual character to a cloud.

It is further conceivable that user 400 may also generate a virtual character specific with improved customizability and an efficient way to create avatars compared to the non-lingual and manual selection of avatars through an interface.

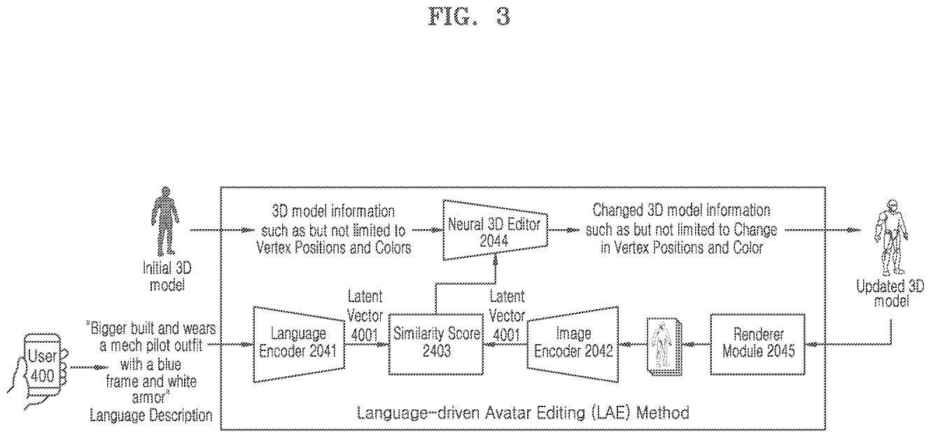

According to FIG. 3, inputs are primarily, but not limited to, the initial 3D model of the avatar and the language description.

According to an embodiment of the disclosure shown in FIG. 3, the language-driven avatar editing (LAE) module 204 may comprise several subcomponents which serve different roles. Each subcomponent may utilize model(s). The model(s) utilized by the sub-component may be statistical, rule-based, machine learning, or deep learning model(s). Sub-components of module 204 are elaborated as follows:
1. at least one language encoder 2041 for encoding the language description into an at least one latent vector 4001.
2. at least one image encoder 2042 for encoding 2D images into another at least one latent vector 4001. Additionally, language encoder 2041 and image encoder 2042 are trained to generate the at least one latent vector 4001 in a joint embedding for language and images.
3. at least one similarity score module 2403 for computing the similarity score from the at least one latent vector 4001 generated by the at least one language encoder 2041 and the at least one image encoder 2042. The score is used to update the weights of the neural 3D editor.
4. at least one neural 3D editor 2044 for generating the change in position and color of the initial 3D model's vertices to update the avatar. Editor 2044 takes in information from the initial 3D model such as but not limited to vertex positions and colors. The output of the component generates a change in values from the input information to apply updates to the 3D model.
5. at least one renderer module 2045—Renders 2D images of the updated 3D model across multiple viewpoints.

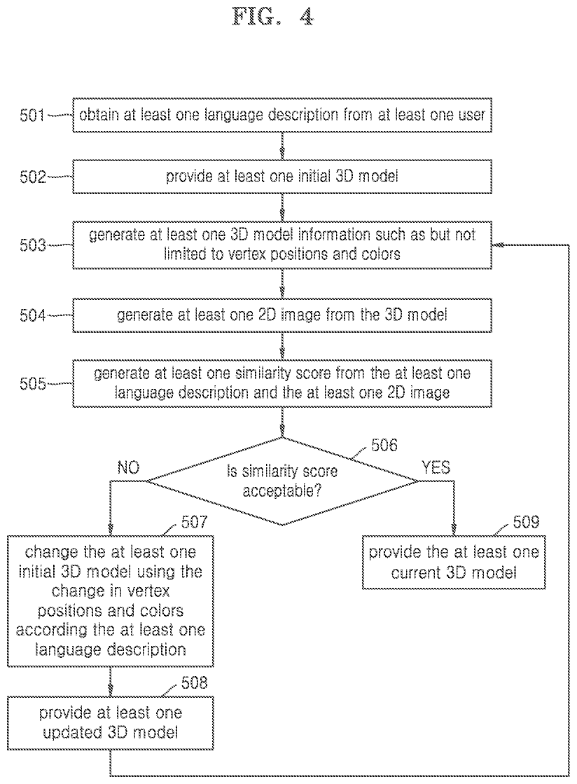

FIG. 4 shows method of an embodiment of the disclosure. The method includes the steps of:
1. obtaining an at least one language description from at least one user 501;
2. providing an at least one 3D initial model of the avatar 502;
3. generating an at least one 3D model information such as but not limited to vertex positions and colors 503;
4. generating at least one 2D image from the at least one 3D model 504;
5. generating an at least one similarity score from the at least one language description and the at least one 2D image 505;
6. assessing if the at least one similarity score is acceptable within an at least one threshold 506;
7. if the at least one similarity score from item (6) is not satisfied or within the at least one threshold, changing the at least one initial 3D model using the change in vertex positions and colors according the at least one language description 507;
8. providing an at least one updated model 508 and then returning to execute items (3) to (6) again; and
9. if the at least one similarity score from item (6) is satisfied, providing an at least one updated 3D model 509.

The method's output is primarily, but not limited to, the updated 3D model of the avatar.

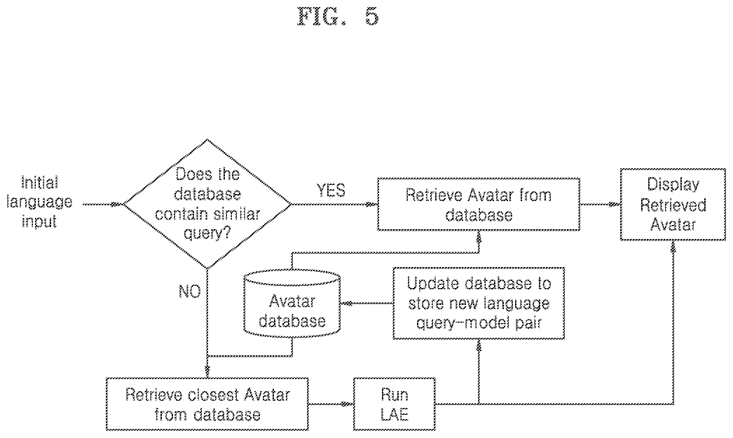

According to FIG. 5, an embodiment of the disclosure includes an avatar retrieval method where a database of avatars with language descriptions can be used to retrieve a pre-built 3D model to speed up the avatar creation process. This database can be expanded to store previous language queries and the generated 3D avatar model. The model(s) used to determine if the database contains a similar query may be statistical, rule-based, machine learning, or deep learning model(s).

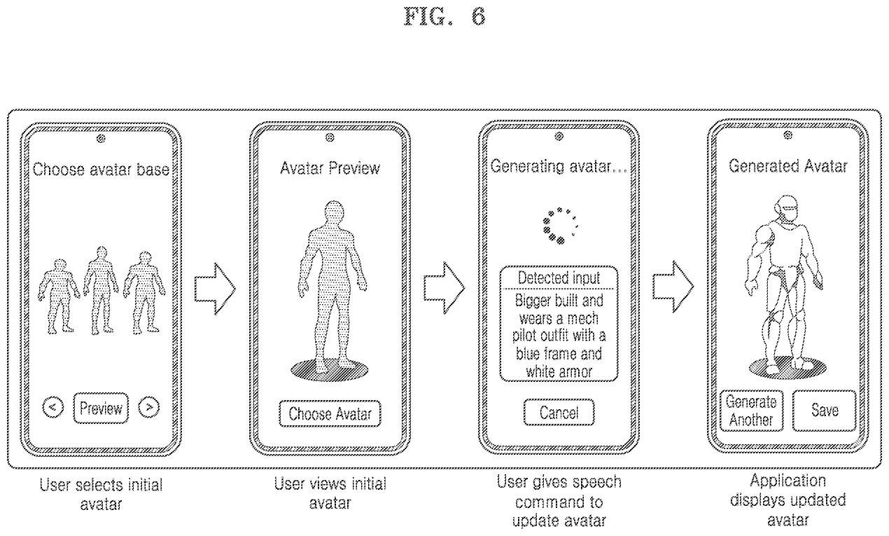

As shown in FIG. 6, according to an embodiment of the disclosure can be deployed in a mobile device running a program implementing the described method. In particular, an avatar base may be selected via user interface 300 through avatar generation and editing application 202 of the mobile device, the user provides a speech command of the language description for avatar editing. System 100 detects the input and implements the language-driven avatar editing method, and the user interface displays the updated avatar via avatar generation and editing application 202.

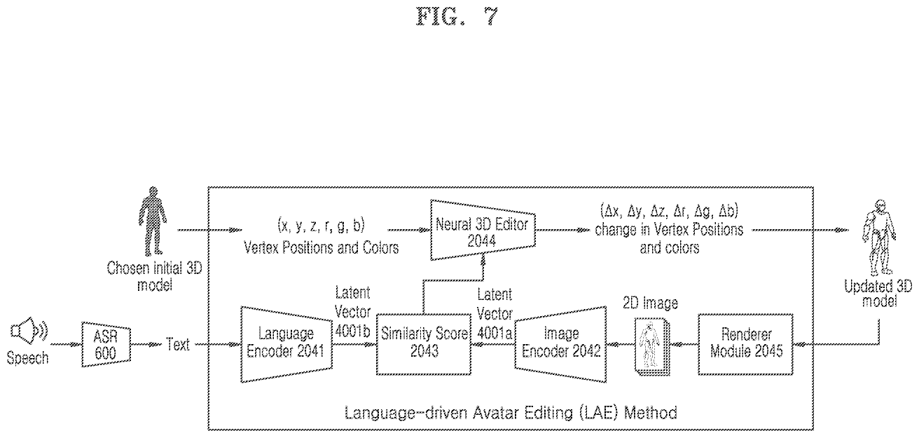

According to an embodiment of the disclosure as shown in FIG. 7, vertex positions and colors from the initial 3D model in a form 3D mesh are used as input to neural 3D editor module 2044. Neural 3D editor module 2044, preferably, is a neural network that learns how the vertex positions and colors of the 3D model can be updated to fit the language description. The input is the vertex position and color information, and the output is the change in position and color. See FIG. 7 at the output of 2044 (Δx, Δy, Δz, Δr, Δg, Δb), where x, y and z are position variables and r, g, b (red, green, blue) are color intensities. The generated changes in vertex and color positions of neural 3D editor module 2044 are used to create an updated 3D model. Renderer module 2045 is used to project the updated 3D model into 2D images with respect to camera viewpoints around the updated 3D model. These 2D images are then encoded to a latent vector using image encoder 2042. At least one encoded latent vector 4001a of the images is compared to at least one encoded latent vector 4001b from language encoder 2041.

The similarity score can be implemented in similarity score module 2043 using cosine similarity or any other similarity score algorithms/models. Language encoder 2041 and image encoder 2042 are trained to encode the image and language input to joint embedding. An embedding is a representation in which similar items are close to each other according to a distance measure. A latent vector is an intermediate representation.

According to an embodiment of the disclosure, as shown in FIG. 7, an at least one automatic speech recognition (ASR) model 600 can be used to convert speech input to text so that the method can use speech or text as input. This method stops when the similarity score increases beyond a predetermined threshold.

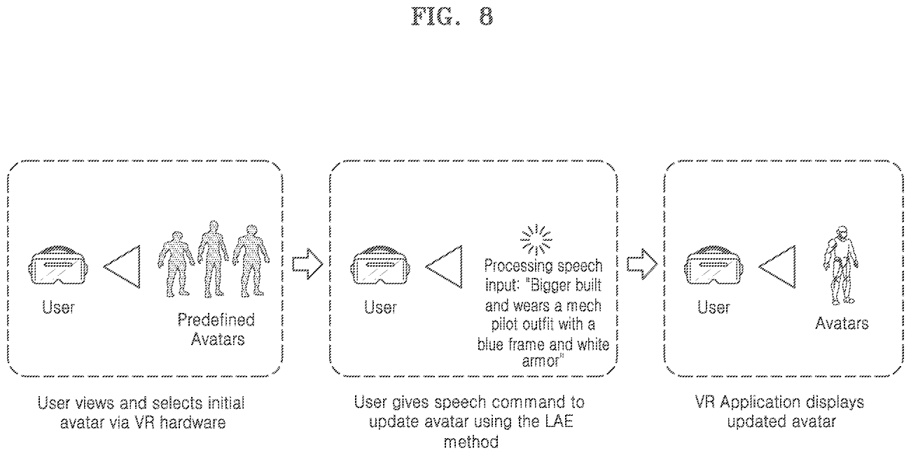

An embodiment of the disclosure is configured in a VR headset running a program implementing the described method as shown in FIG. 8.

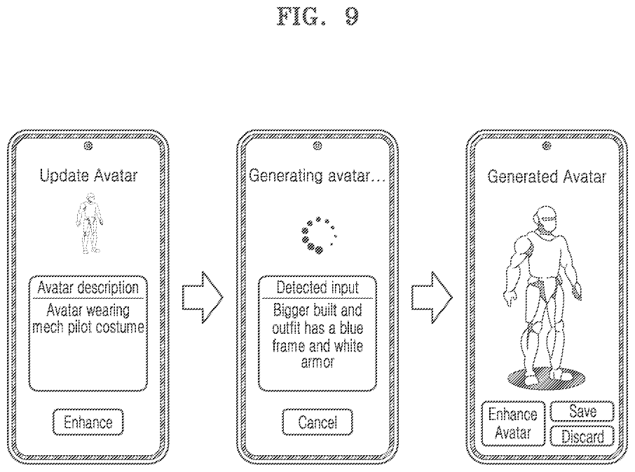

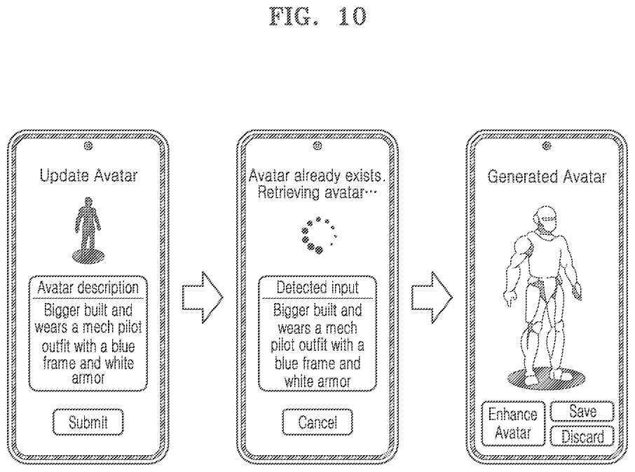

FIG. 9 and FIG. 10 refer to an embodiment of the disclosure wherein system 100 may store previous and predefined pairs of language query with corresponding 3D avatars in a database to speed up the avatar creation method.

FIG. 9 shows an embodiment of the disclosure in which the text description is used alongside a speech input on the 2nd part to generate the avatar.

FIG. 10 shows an embodiment of the disclosure in which the received input to generate the avatar has a similar corresponding query in the database. The 3D avatar model which corresponds to the similar query found is displayed back to the user. User can give more descriptions and use the method of an embodiment of the disclosure or accept the retrieved avatar.

System 100 can store previous and predefined pairs of language query with corresponding 3D avatars in a database to speed up the avatar creation method.

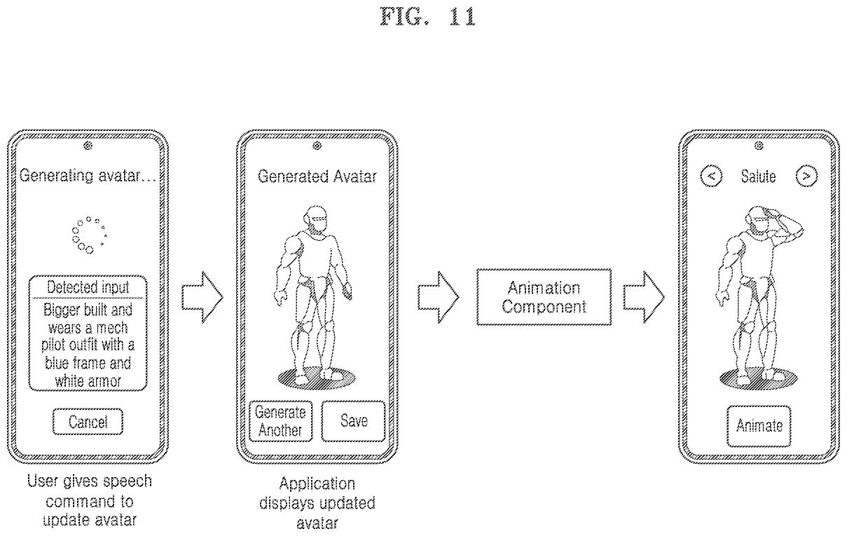

According to an embodiment of the disclosure as shown in FIG. 11, system 100 can be deployed with an animation component utilizing automatic rigging algorithms or similar algorithm(s) to animate the avatars. The animation component may also be contained in the at least one avatar generation and editing application 202 as an optional extension for viewing the generated avatar.

According to an embodiment of the disclosure, the VR hardware may comprise a headset with a display for each eye, a processor and a memory. See FIG. 8 illustrating the user wearing the VR hardware.

According to an embodiment of the disclosure, the first latent vector is an embedding in which similar items are close to each other according to a distance measure. For example, in FIG. 7 latent vectors 4001b and 4001a can be compared by a distance measure such as cosine similarity.

According to an embodiment of the disclosure, the method may include presenting, on a display of a VR hardware, predefined avatars to a user wearing the VR hardware. See FIG. 8 in which the user sees the predefined avatars.

According to an embodiment of the disclosure, the method may include receiving the speech input from the VR hardware worn by the user. See FIG. 8 in which the user provides the speech input “bigger built . . . and white armor.”

According to an embodiment of the disclosure, the method may include displaying the 3D model of the figure representation on the display of the VR hardware worn by the user. See FIG. 8 in which the updated avatar is displayed.

According to an embodiment of the disclosure, the method may include receiving a second speech input or a touch input from the user indicating that the 3D model of the figure is to be saved in memory. See FIG. 9 providing a save option on an example user interface.

According to an embodiment of the disclosure, the method may include receiving a third speech input or second touch input from the user indicating that the 3D model of the figure is to be discarded. See FIG. 10 illustrating a discard option on an example user interface.

According to an embodiment of the disclosure, the method may include receiving a fourth speech input or third touch input from the user indicating that the 3D model of the figure is to be animated to move an arm position of the 3D model. See FIG. 11 in which the figure is animated to salute.

An embodiment of the disclosure may provide editing of 3D avatars using plain language descriptions in either speech or text form without rule-based methods to parse the description.

An embodiment of the disclosure may provide avatar generation or editing module 204 and do not require any predefined avatar body parts when configuring. An embodiment of the disclosure may directly generate avatars from language descriptions.

According to an embodiment of the disclosure, communication among system components may be via any transmitter or receiver used for Wi-Fi, Bluetooth, infrared, radio frequency, NFC cellular communication, visible light communication, Li-Fi, WiMAX, ZigBee, fiber optics, and other forms of wireless communication devices. Alternatively, communication may also be via a physical channel such as a USB cable or other forms of wired communication.

Computer software programs and algorithms—those including machine learning and predictive algorithms—may be written in any of various suitable programming languages, such as C, C++, C#, Pascal, Fortran, Perl, MATLAB (from MathWorks, www.mathworks.com), SAS, SPS S, JavaScript, CoffeeScript, Objective-C, Objective-J, Ruby, Python, Erlang, Lisp, Scala, Clojure, and Java. The computer software programs may be independent applications with data input and data display modules. Alternatively, the computer software programs may be classes that may be instantiated as distributed objects. The computer software programs may also be component software such as Java Beans (from Oracle) or Enterprise Java Beans (EJB from Oracle).

Furthermore, application modules or modules as described herein may be stored, managed, and accessed by an at least one computing server. Moreover, application modules may be connected to a network and interface to other application modules. The network may be an intranet, internet, or the Internet, among others. The network may be a wired network (e.g., using copper), telephone network, packet network, optical network (e.g., using optical fiber), or a wireless network or any combination of these. For example, data and other information may be passed between the computer and components (or steps) of a system useful in practicing the systems and methods in this application using the wireless network employing a protocol such as Wi-Fi (IEEE standards 802.12, 802.12a, 802.12b, 802.12e, 802.12g, 802.12i, and 802.12n, just to name a few examples). For example, signals from a computer may be transferred, at least in part, wirelessly to components or other computers.

It is contemplated for an embodiment of the disclosure described herein to extend to individual elements and concepts described herein, independently of other concepts, ideas or system, as well as for an embodiment of the disclosure to include combinations of elements recited anywhere in this application. Claim scope is not limited to an embodiment of the disclosure described in detail herein with reference to the accompanying drawings. As such, many variations and modifications will be apparent to practitioners skilled in this art. Illustrative an embodiment of the disclosure such as those depicted refer to a preferred form but is not limited to its constraints and is subject to modification and alternative forms. A feature described either individually or as part of an embodiment may be combined with other individually described features, or parts of other embodiments, even if the other features and embodiments make no mention of the said feature.

An embodiment of the disclosure may provide a system and method for language-driven editing and customization of avatars in mobile devices, VR hardware, and other digital devices. An embodiment of the disclosure may make editing and customization of avatars or figure representations of persons a less time-consuming method by directly using natural language descriptions in text or speech to modify an existing avatar 3D model. Natural language is rich in information and can describe complex appearances that the user wants the avatar to appear in such that textual information is used to enhance the features of a generated 3D avatar.

An embodiment of the disclosure may provide a system and method for editing 3D avatars or figure representations of a user using plain language descriptions in either speech or text form without rule-based methods to parse the description.

An embodiment of the disclosure relates to a system and method of generating a 3D model representation or an avatar of a user by rendering information such as vectors obtained from sensor input, visual input, auditory input, as well as language description input, mainly reliant on textual information for further enhancement of the generated 3D model. The input data are processed through rule-based, machine learning, and/or deep learning models.

Compared to the prior art, An embodiment of the disclosure is not limited to existing assets in databases and provides more flexibility by not limiting processes to generic algorithms for enhancements and generation. It is likewise applicable to 3D avatars by directly modifying the vertex positions and color of the 3D mesh of the avatar.

Provided herein is a system for language-driven editing of figure representation of persons, the system comprising: at least one processor; at least one memory device in communication with the at least one processor; an operating system stored in the at least one memory device; an avatar generating and editing application in communication with the operating system; a language-driven editing module implemented through the operating system; a graphical user interface implemented through the operating system; a user interface configured to receive a language description; a display device in communication with the user interface; a virtual reality hardware (VR hardware) in communication with the user interface; an image capturing device in communication with the user interface; and an audio capturing device in communication with the user interface, wherein the avatar generating and editing application comprises: at least one data storage, a second user interface, and an avatar-creating module.

According to an embodiment of the disclosure, the system may include a language-driven figure representation editing module comprising: a language encoder configured to encode the language description into a first latent vector; a similarity score computing module to take in information from an initial 3D model, the information comprising vertex positions and colors; a neural 3D editor configured to generate a change in position and color of the initial 3D model's vertices to update the figure representation; a renderer module configured to render 2D images of the updated 3D model across multiple view points; and an image encoder configured to encode the rendered 2D images into a second latent vector, wherein the language encoder and the image encoder are trained to generate the first latent vector and the second latent vector, in a joint embedding for language and images.

According to an embodiment of the disclosure, a similarity score is computed from the first latent vector and the second latent vector such that the similarity score is used to update weights of the neural 3D editor.

According to an embodiment of the disclosure, the neural 3D editor is configured to update the 3D model based on the weights of the neural 3D editor.

Also provided herein is a method of generating a figure representation of persons, the method comprising: receiving a description input comprising audio, video, text, and/or a photo from the image capturing device and/or the audio capturing device; receiving sensor data from the sensor; processing, using the system described above, the description input and the sensor data to generate a 3D model of the figure representation; and outputting a 3D model of the figure representation.

Also provided herein is a method of language-driven editing of a generated figure representation, the method comprising: inputting vertex positions and colors from an initial 3D model in a form 3D mesh to a neural 3D editor module; inputting speech input for a language description; processing the vertex positions and colors of the 3D model through a neural network via a 3D editor module; converting the speech input to text through an automatic speech recognition model; updating the 3D model and the vertex positions to fit the language description through the 3D editor module, wherein an input is a vertex position and color information and an output is a change in position and color; rendering the updated 3D model into 2D images with respect to camera viewpoints around the updated 3D model through a renderer; obtaining a second latent vector from the 2D images using an image encoder; obtaining a first latent vector from a language encoding; comparing, using a similarity score, the first latent vector and the second latent vector; and outputting, based on the second latent vector, a 3D model of a figure representation after a determination that the similarity score is above a threshold.

According to an embodiment of the disclosure, the method may include performing operations of the inputting the vertex positions through the outputting the 3D model on a mobile device.

According to an embodiment of the disclosure, the method may include animating the 3D model using an automatic rigging algorithm.

According to an embodiment of the disclosure, the method may include retrieving the initial 3D model from a database of avatars with language descriptions.

According to an embodiment of the disclosure, the VR hardware comprises a headset with a display for each eye, a processor and a memory.

According to an embodiment of the disclosure, the image capturing device is a camera.

According to an embodiment of the disclosure, the audio capturing device is a microphone.

According to an embodiment of the disclosure, the similarity score is a cosine similarity.

According to an embodiment of the disclosure, the first latent vector is an embedding in which similar items are close to each other according to a distance measure.

According to an embodiment of the disclosure, the method may include presenting, on a display of a VR hardware, predefined avatars to a user wearing the VR hardware.

According to an embodiment of the disclosure, the method may include receiving the speech input from the VR hardware worn by the user.

According to an embodiment of the disclosure, the method may include displaying the 3D model of the figure representation on the display of the VR hardware worn by the user.

According to an embodiment of the disclosure, the method may include receiving a second speech input from the user indicating that the 3D model of the figure is to be saved in memory.

According to an embodiment of the disclosure, the method may include receiving a third speech input or second touch input from the user indicating that the 3D model of the figure is to be discarded.

According to an embodiment of the disclosure, the method may include receiving a fourth speech input or third touch input from the user indicating that the 3D model of the figure is to be animated to move an arm position of the 3D model.

According to an embodiment of the disclosure, the method may include receiving a first input including language description.

According to an embodiment of the disclosure, the method may include obtaining a first latent vector based on the first input.

According to an embodiment of the disclosure, the method may include updating an initial avatar model to a first three-dimensional avatar model based on the first latent vector.

According to an embodiment of the disclosure, the method may include displaying the first three-dimensional avatar model.

According to an embodiment of the disclosure, the method may include obtaining at least one two-dimensional image for a plurality of view points from the first three-dimensional avatar model.

According to an embodiment of the disclosure, the method may include obtaining a second latent vector from the at least one two-dimensional image.

According to an embodiment of the disclosure, the method may include obtaining similarity between the first latent vector and the second latent vector.

According to an embodiment of the disclosure, the method may include updating the first three dimensional avatar model to a second three-dimensional avatar model based on the similarity.

According to an embodiment of the disclosure, the method may include displaying the second three-dimensional avatar model.

According to an embodiment of the disclosure, the method may include obtaining the similarity between the first latent vector and the second latent vector based on a joint embedding.

According to an embodiment of the disclosure, the method may include obtaining a first information regarding at least one vertex position and at least one color from the first three-dimensional avatar model.

According to an embodiment of the disclosure, the method may include obtaining a second information regarding changes in the at least one vertex position and the at least one color based on the similarity and the first information.

According to an embodiment of the disclosure, the method may include updating the first three-dimensional avatar model to the second three-dimensional avatar model based on the second information.

According to an embodiment of the disclosure, the language description is obtained based on at least one of audio, video, text, photo, compiled instructions, customized files, sensor data, user selected option or multi-modal input.

According to an embodiment of the disclosure, the method may include storing queries of the first input and at least one of the first three-dimensional avatar model or the second three-dimensional avatar model obtained based on the first input.

According to an embodiment of the disclosure, the method may include identifying whether a second input corresponds with the first input.

According to an embodiment of the disclosure, the method may include in case that the second input corresponds with the queries of the first input, displaying stored at least one of the first three-dimensional avatar model or the second three-dimensional avatar model corresponding with the first input.

According to an embodiment of the disclosure, the method may include, in case that the second input does not corresponds with the queries of the first input, retrieving a third three-dimensional avatar model close to the second input from the stored at least one of the first three-dimensional model or the second dimensional model.

According to an embodiment of the disclosure, the method may include, in case that the second input does not corresponds with the queries of the first input, obtaining a third latent vector based on the second input

According to an embodiment of the disclosure, the method may include, in case that the second input does not corresponds with the queries of the first input, updating the third three-dimensional avatar model to a forth three-dimensional avatar model based on the third latent vector

According to an embodiment of the disclosure, the method may include, in case that the second input does not corresponds with the queries of the first input, displaying the forth three-dimensional avatar model.

According to an embodiment of the disclosure, the method may include storing queries of the second input and at least one of the third three-dimensional avatar model or the forth three-dimensional avatar model obtained based on the second input.

According to an embodiment of the disclosure, the method may include displaying at least one of the first three-dimensional avatar model or the second three-dimensional avatar model into an animation mode.

According to an embodiment of the disclosure, the device may include at least one memory storing at least one instruction and at least one processor configured to execute the at least one instruction stored in the memory.

According to an embodiment of the disclosure, at least one processor is configured to receive a first input including language description.

According to an embodiment of the disclosure, at least one processor is configured to obtain a first latent vector based on the first input.

According to an embodiment of the disclosure, at least one processor is configured to update an initial avatar model to a first three-dimensional avatar model based on the first latent vector.

According to an embodiment of the disclosure, at least one processor is configured to display the first three-dimensional avatar model.

According to an embodiment of the disclosure, at least one processor is configured to obtain at least one two-dimensional image for a plurality of view points from the first three-dimensional avatar model.

According to an embodiment of the disclosure, at least one processor is configured to obtain a second latent vector from the at least one two-dimensional image.

According to an embodiment of the disclosure, at least one processor is configured to obtain similarity between the first latent vector and the second latent vector.

According to an embodiment of the disclosure, at least one processor is configured to update the first three dimensional avatar model to a second three-dimensional avatar model based on the similarity.

According to an embodiment of the disclosure, at least one processor is configured to display the second three-dimensional avatar model.

According to an embodiment of the disclosure, at least one processor is configured to obtain the similarity between the first latent vector and the second latent vector based on a joint embedding.

According to an embodiment of the disclosure, at least one processor is configured to obtain a first information regarding at least one vertex position and at least one color from the first three-dimensional avatar model.

According to an embodiment of the disclosure, at least one processor is configured to obtain a second information regarding changes in the at least one vertex position and the at least one color based on the similarity and the first information.

According to an embodiment of the disclosure, at least one processor is configured to update the first three-dimensional avatar model to the second three-dimensional avatar model based on the second information.

According to an embodiment of the disclosure, at least one processor is configured to store queries of the first input and at least one of the first three-dimensional avatar model or the second three-dimensional avatar model obtained based on the first input.

According to an embodiment of the disclosure, at least one processor is configured to identify whether a second input corresponds with the first input.

According to an embodiment of the disclosure, at least one processor is configured to, in case that the second input does not corresponds with the queries of the first input, retrieve a third three-dimensional avatar model close to the second input from the stored at least one of the first three-dimensional model or the second dimensional model

According to an embodiment of the disclosure, at least one processor is configured to, in case that the second input does not corresponds with the queries of the first input, obtain a third latent vector based on the second input.

According to an embodiment of the disclosure, at least one processor is configured to, in case that the second input does not corresponds with the queries of the first input, update the third three-dimensional avatar model to a forth three-dimensional avatar model based on the third latent vector.

According to an embodiment of the disclosure, at least one processor is configured to, in case that the second input does not corresponds with the queries of the first input, display the forth three-dimensional avatar model.

According to an embodiment of the disclosure, at least one processor is configured to store queries of the second input and at least one of the third three-dimensional avatar model or the forth three-dimensional avatar model obtained based on the second input.

According to an embodiment of the disclosure, at least one processor is configured to display at least one of the first three-dimensional avatar model or the second three-dimensional avatar model into an animation mode.

1. A method for editing avatar model based on language-driven, the method comprising:
receiving a first input including language description;
obtaining a first latent vector based on the first input;
updating an initial avatar model to a first three-dimensional avatar model based on the first latent vector; and
displaying the first three-dimensional avatar model.

2. The method of 1, further comprising:
obtaining at least one two-dimensional image for a plurality of view points from the first three-dimensional avatar model;
obtaining a second latent vector from the at least one two-dimensional image;
obtaining similarity between the first latent vector and the second latent vector;
updating the first three dimensional avatar model to a second three-dimensional avatar model based on the similarity; and
displaying the second three-dimensional avatar model.

3. The method of 2, wherein obtaining the similarity between the first latent vector and the second latent vector further comprises:
obtaining the similarity between the first latent vector and the second latent vector based on a joint embedding

4. The method of 2, wherein updating the first three-dimensional avatar model to the second three-dimensional avatar model further comprises:
obtaining a first information regarding at least one vertex position and at least one color from the first three-dimensional avatar model;
obtaining a second information regarding changes in the at least one vertex position and the at least one color based on the similarity and the first information; and
updating the first three-dimensional avatar model to the second three-dimensional avatar model based on the second information.

5. The method of 1, wherein the language description is obtained based on at least one of audio, video, text, photo, compiled instructions, customized files, sensor data, user selected option or multi-modal input.

6. The method of 1, further comprising:
storing queries of the first input and at least one of the first three-dimensional avatar model or the second three-dimensional avatar model obtained based on the first input; and
identifying whether a second input corresponds with the first input.

7. The method of 6, further comprising:
in case that the second input corresponds with the queries of the first input, displaying stored at least one of the first three-dimensional avatar model or the second three-dimensional avatar model corresponding with the first input.

8. The method of 6, further comprising:
in case that the second input does not corresponds with the queries of the first input,
retrieving a third three-dimensional avatar model close to the second input from the stored at least one of the first three-dimensional model or the second dimensional model;
obtaining a third latent vector based on the second input;
updating the third three-dimensional avatar model to a forth three-dimensional avatar model based on the third latent vector; and
displaying the forth three-dimensional avatar model.

9. The method of 8, further comprising:
storing queries of the second input and at least one of the third three-dimensional avatar model or the forth three-dimensional avatar model obtained based on the second input.

10. The method of 1, further comprising:
displaying at least one of the first three-dimensional avatar model or the second three-dimensional avatar model into an animation mode.

11. A device for editing avatar model based on language-driven, the device comprising:
at least one memory storing at least one instruction; and
at least one processor configured to execute the at least one instruction stored in the memory to:
receive a first input including language description;
obtain a first latent vector based on the first input;
update an initial avatar model to a first three-dimensional avatar model based on the first latent vector; and
display the first three-dimensional avatar model.

12. The device of claim 11, wherein the processor is further configured to:
obtain at least one two-dimensional image for a plurality of view points from the first three-dimensional avatar model;
obtain a second latent vector from the at least one two-dimensional image;
obtain similarity between the first latent vector and the second latent vector;
update the first three dimensional avatar model to a second three-dimensional avatar model based on the similarity; and
display the second three-dimensional avatar model.

13. The device of claim 12, wherein the processor is further configured to:
obtain the similarity between the first latent vector and the second latent vector based on a joint embedding.

14. The device of claim 12, wherein the processor is further configured to:
obtain a first information regarding at least one vertex position and at least one color from the first three-dimensional avatar model;
obtain a second information regarding changes in the at least one vertex position and the at least one color based on the similarity and the first information; and
update the first three-dimensional avatar model to the second three-dimensional avatar model based on the second information.

15. The device of claim 11, wherein the language description is obtained based on at least one of audio, video, text, photo, compiled instructions, customized files, sensor data, user selected option or multi-modal input

16. The device of claim 11, wherein the processor is further configured to:
store queries of the first input and at least one of the first three-dimensional avatar model or the second three-dimensional avatar model obtained based on the first input; and
identify whether a second input corresponds with the first input.

17. The device of claim 16, wherein the processor is further configured to:
in case that the second input corresponds with the queries of the first input, display stored at least one of the first three-dimensional avatar model or the second three-dimensional avatar model corresponding with the first input.

18. The device of claim 16, wherein the processor is further configured to:
in case that the second input does not corresponds with the queries of the first input,
retrieve a third three-dimensional avatar model close to the second input from the stored at least one of the first three-dimensional model or the second dimensional model;
obtain a third latent vector based on the second input;
update the third three-dimensional avatar model to a forth three-dimensional avatar model based on the third latent vector; and
display the forth three-dimensional avatar model.

19. The device of claim 18, wherein the processor is further configured to:
store queries of the second input and at least one of the third three-dimensional avatar model or the forth three-dimensional avatar model obtained based on the second input.

20. The device of claim 11, wherein the processor is further configured to:
display at least one of the first three-dimensional avatar model or the second three-dimensional avatar model into an animation mode.
